(19) United States
(12) Patent Application Publication
(10) Pub. No.: US 2013/0319089 A1
(43) Pub. Date: Dec. 5, 2013

(54) METHOD FOR DETERMINING THE MAGNITUDE OF AN IRRIGATION EVENT IN A SECTION OF SOIL, AND RELATED SYSTEMS

(71) Applicant: Jac le Roux, The Dalles, OR (US)

(72) Inventor: Jac le Roux, The Dalles, OR (US)

(21) Appl. No.: 13/878,409

(22) PCT Filed: Feb. 21, 2012
(86) PCT No.: PCT/US12/25954

§ 371 Date: Apr. 8, 2013

Related U.S. Application Data
(60) Provisional application No. 61/445,400, filed on Feb. 22, 2011.

(51) Int. Cl. G01N 19/10

(52) U.S. Cl. CPC G01N 19/10
USPC 73/73

(57) ABSTRACT

A method for determining an amount of moisture that has entered a section of soil via irrigation, includes sensing at a first moment in time a total amount of moisture in a sub-section of the section of soil, and in response to the amount sensed at the first moment in time, determining a total amount of moisture, Wᵢₙᵢₜᵢₐₗ, in the section of soil at the first moment in time. Sensing at a second, subsequent moment in time a total amount of moisture in a sub-section of the section of soil, and in response to the amount sensed at the second moment in time, determining a total amount of moisture, Wₜₒₜ, in the section of soil at the second moment in time. Then, comparing the two Wᵢₙᵢₜᵢₐₗ and Wₜₒₜ by, for example, subtracting Wᵢₙᵢₜᵢₐₗ from Wₜₒₜ. The method also includes determining an amount of moisture that has entered the section of soil during a period between the first and second moments in time via natural precipitation, and determining an amount of moisture that has left the section of soil during the period between the first and second moments in time. Then, adding to the comparison of the two Wᵢₙᵢₜᵢₐₗ and Wₜₒₜ the determined amount of moisture that has left the section of soil, and subtracting from this amount the determined amount of moisture that has entered the section of soil.

### CROSS REFERENCE TO RELATED APPLICATION AND CLAIM OF PRIORITY

This application claims priority from commonly owned U.S. Provisional Patent Application 61/445,400 filed 22 Feb. 2011, and titled “Probe Schedule Systems and Related Methods”, presently pending, which is incorporated by reference.

### BACKGROUND

Cultivating crops, such as grains, vegetables, fruits and grasses, for future sale requires careful attention to the amount of radiation from the sun and the amount of moisture, such as liquid water, that the crops receive. The crops receive moisture through a variety of mechanisms. For example, most crops can access moisture from the air in humid environments and from the soil when moisture is held in the soil. Because, cultivators can more easily exercise control over the conditions in the soil, most cultivators modify the amount of moisture that their crops receive by modifying the amount of water held in the soil.

Because crops receive moisture held in the soil via their roots, the section of the soil that cultivators monitor and manage is the section of soil in which the crop's roots are disposed—the root zone. The area and depth of a crop's root zone depends on the specific crop, its age and the current season. For example, the root zone of a mature tree in spring is typically fifteen feet by eighteen feet across, and three feet deep. During the summer, the root zone of the tree might expand an inch or two across by another inch or two deep. The root zone of broccoli is typically two feet across by eight inches deep, when mature and in summer.

The amount of moisture held in the root zone of a crop at any specific moment in time depends on many different factors existing in a period immediately preceding the specific moment in time. In general these factors include the composition of the soil (clay holds much moisture, whereas sand holds little), the weather that the soil is exposed to during the preceding period (for example rain, sun, air temperature, air humidity) and the crop's consumption of moisture during the preceding period (which includes the moisture that the crop retains and the moisture that the crop transpires). In general, the amount of moisture at any specific moment in the soil's root zone that promotes efficient growth of the crop ranges between 70% and 100% of the root zone's total capacity. To determine the amount of moisture held in a crop's root zone, a cultivator subtracts the amount of moisture that the crop consumes during the period from the amount of moisture that enters the root zone during the period, then the cultivator adds this net amount to the amount of moisture held by the root zone at the beginning of the period. This calculated amount represents the amount of moisture held in the root zone of the soil at the end of the period, and may be used as the amount of moisture in the root zone at the beginning of another period.

Because it's typically more convenient for the cultivator to add moisture to the crop's root zone, the cultivator monitors the amount of moisture in the root zone and manages this amount by adding moisture via irrigation when the cultivator determines that moisture needs to be added to the section of soil that includes the crop's root zone. To prevent excessive irrigation and thus wasting moisture that the cultivator could use for other crops or that another cultivator could use for their crops, the cultivator monitors the amount of moisture added via irrigation and its effect on the section of soil that includes the crop's root zone. To monitor the amount of moisture added via irrigation, the cultivator tracks the duration and the flow rate of the irrigation. To monitor the amount of moisture held by a section of soil, the cultivator typically uses a moisture probe disposed in the root zone.

Current, accurate moisture probes measure the amount of moisture in a section of soil by generating high energy neutrons, emitting these neutrons into the soil, and then sensing low energy neutrons in the soil. Because high energy neutrons lose energy when they collide with hydrogen, which moisture has, the concentration of low energy neutrons correlates to the amount of moisture in the soil. Such moisture probes are very expensive to purchase and require calibration. Thus, many cultivators use a few moisture probes and assume that the amount of moisture sensed in one section of the soil will be very similar to the amount of moisture sensed in neighboring sections of the soil.

Unfortunately, tracking the duration and flow rate of an irrigation event can be time consuming for cultivators. Thus, many cultivators hire a person to physically monitor the irrigation event. The cost for such a person can be more than the cultivator can easily afford, so many cultivator's add this tracking responsibility to the responsibilities of another employee. Because tracking the duration and flow rate of an irrigation event is time consuming, many employees responsible for this don't thoroughly monitor the irrigation event. Thus, the calculation of the total amount of moisture added to the crop's root zone may not be accurate, and thus the determined amount of moisture held by the section of soil that includes the root zone may not be accurate.

### SUMMARY

In an aspect of the invention, a method for determining an amount of moisture that has entered a section of soil via irrigation, includes sensing at a first moment in time a total amount of moisture in a sub-section of the section of soil, and in response to the amount sensed at the first moment in time, determining a total amount of moisture, Wᵢₙᵢₜᵢₐₗ, in the section of soil at the first moment in time. Sensing at a second, subsequent moment in time a total amount of moisture in a sub-section of the section of soil, and in response to the amount sensed at the second moment in time, determining a total amount of moisture, Wₜₒₜ, in the section of soil at the second moment in time. Then, comparing the two Wᵢₙᵢₜᵢₐₗ and Wₜₒₜ by, for example, subtracting Wᵢₙᵢₜᵢₐₗ from Wₜₒₜ. The method also includes determining an amount of moisture that has entered the section of soil during a period between the first and second moments in time via natural precipitation, and determining an amount of moisture that has left the section of soil during the period between the first and second moments in time. Then, adding to the comparison of the two, Wᵢₙᵢₜᵢₐₗ and Wₜₒₜ, the determined amount of moisture that has left the section of soil, and subtracting from this amount the determined amount of moisture that has entered the section of soil.

By determining, in this manner, an amount of moisture that has entered a section of soil via irrigation, the person in charge of irrigating one's crops does not have to keep track and report the amount of moisture provided during irrigation and the duration of the irrigation. Thus, the person in charge of irrigating one's crops only needs to ensure that the irrigation is started and finished as desired. If something happens during the irrigation, such as the amount of moisture provided to the crops increases or decreases, the method will discover this and can alert the person in charge of irrigating the crops to adjust the next irrigation's duration, amount of moisture provided, or both, to compensate for the previous irrigation event.

In another aspect of the invention, a storage medium storing a program that, when executed by a computer, causes the computer to determine an amount of moisture that has entered a section of soil via irrigation, the determination performed by the computer includes: 1) determining a total amount of moisture, Wᵢₙᵢₜᵢₐₗ, in the section of soil at the first moment in time, 2) determining a total amount of moisture, Wₜₒₜ, in the section of soil at a second moment in time, 3) comparing the two, determined total amounts of moisture in the section of soil, 4) determining an amount of moisture that has entered the section of soil during a period between the first and second moments in time via natural precipitation, 5) determining an amount of moisture that has left the section of soil during the period between the first and second moments in time, 6) adding to the comparison of the two, Wᵢₙᵢₜᵢₐₗ and Wₜₒₜ, the determined amount of moisture that has left the section of soil, and 7) subtracting the determined amount of moisture that has entered the section of soil from the comparison of the two, Wᵢₙᵢₜᵢₐₗ and Wₜₒₜ, and the addition of the total amount of moisture leaving the section of soil.

### BRIEF DESCRIPTION OF THE FIGURES

FIG. 1 is a perspective view of a plot of land used to grow crops.

FIG. 2 is a schematic view of a process for monitoring moisture added to a section of soil during a period, according to an embodiment of the invention.

FIG. 3 is a schematic block diagram of a system for monitoring moisture added to a section of soil during a period, according to an embodiment of the invention.

### DETAILED DESCRIPTION

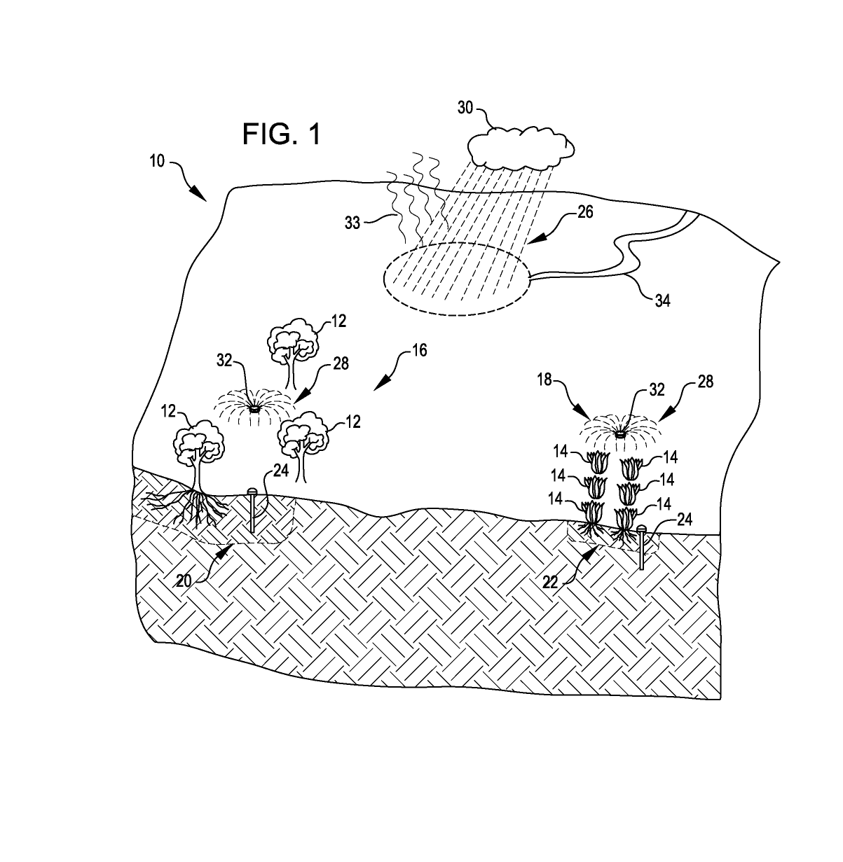

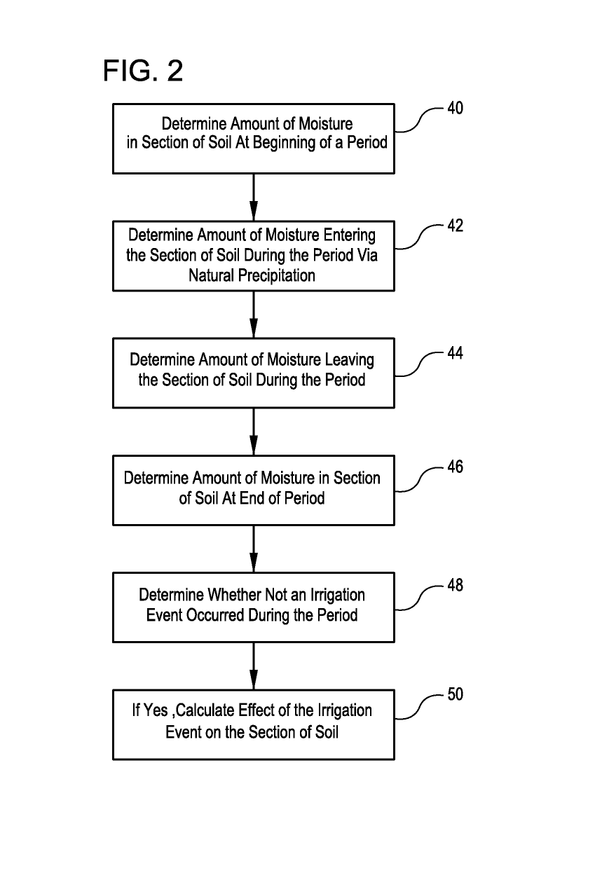

FIG. 1 is a perspective view of a plot of land 10 used to grow crops 12 and 14, and illustrates how moisture (here water in liquid form) enters a section of soil 16 or 18 that includes a crop's root zone 20 or 22, respectively. Here, the crops shown are apple trees 12 and broccoli 14, but the crops grown may be any desired crop, such as carrots or other root vegetables, walnuts or any other desired nuts, grapes or any other desired fruit, wheat or any other desired grains, and green beans or any other desired legumes. Furthermore, the process for monitoring moisture added to a section of soil during a period as discussed in greater detail in conjunction with FIG. 2 may be used to help grow other plants such as grass for an athletic field, and magnolia trees, roses or any other desired plants.

The amount of moisture, Wₜₒₜ, held in each of the root zones 20 and 22 at a moment, tₘ, in time depends on the amount of moisture, Wᵢₙ, entering each of the root zones 20 and 22 during a period, t₁₋ₘ, preceding the moment tₘ, the amount of moisture, Wₒᵤₜ, leaving each of the root zones 20 and 22 during a period, t₁₋ₘ, preceding the moment tₘ, and the amount of moisture, Wᵢₙᵢₜᵢₐₗ, held in each of the root zones 20 and 22 at the beginning, t₁, of the period t₁₋ₘ.

Wₜₒₜ(at tₘ)=Wᵢₙᵢₜᵢₐₗ(at t₁)+Wᵢₙ(during t₁₋ₘ)−Wₒᵤₜ(during t₁₋ₘ)

The amount of moisture, Wᵢₙᵢₜᵢₐₗ, held in each of the root zones 20 and 22 at t₁ may be determined in any desired manner that provides an accurate amount of moisture. For example, the amount, Wᵢₙᵢₜᵢₐₗ, may be determined by sensing, with a moisture probe 24, the amount of moisture in a respective sub-section of each of the root zones 20 and 22, and then extrapolating the results from each sub-section to the respective whole root zones 20 and 22. The amount, Wᵢₙᵢₜᵢₐₗ, may also be determined by using the equation above for a period preceding the moment in time, t₁, that is the beginning of the period t₁₋ₘ. The amount, Wᵢₙᵢₜᵢₐₗ, may also be determined by using a combination of the equation above with the moisture probe 24. For example, both the equation and the moisture probe 24 may be used to determine the amount, Wᵢₙᵢₜᵢₐₗ, by comparing the results from each process and then combining the results to determine the Wᵢₙᵢₜᵢₐₗ that will be used in the above equation to determine the amount of moisture, Wₜₒₜ, held in each of the root zones 20 and 22 at a moment, tₘ.

Moisture, Wᵢₙ, may enter each of the root zones 20 and 22 via rain 26, cultivator-supplied irrigation 28 and/or via absorption from a source of moisture (not shown), such as a water table, below the root zones 20 and 22. When moisture, Wᵢₙ, enters via rain 26 and/or cultivator-supplied irrigation 28, the amount of moisture that is absorbed by each of the root zones 20 and 22 is usually a percentage of the amount of moisture that falls from a cloud 30 in the case of rain 26, or that is emitted from a sprinkler 32 in the case of cultivator-supplied irrigation 28. This is because some of the moisture 33 that falls from a cloud 30 or that is emitted from a sprinkler 32 evaporates into the atmosphere before the respective root zones 20 and 22 can absorb it from their surface. The percentage may also result from some of the moisture running off the surface of the respective root zones 20 and 22 as a stream 34 or river. This often occurs when a large amount of rain falls within a short period. In such a situation, the soil of the respective root zones 20 and 22 cannot absorb the large amount of water lying on their respective surfaces before the water forms the stream 34. Runoff can also occur when the sprinkler 32 has been emitting water toward the same sub-section for too long. In such a situation the soil of the respective root zones 20 and 22 becomes saturated with moisture and thus cannot absorb any additional moisture laying on their respective surfaces before the water forms a stream (not shown).

Moisture, Wₒᵤₜ, may leave each of the root zones 20 and 22 via crop consumption, which includes transpiration, and/or desorption toward a source of moisture (not shown), such as a water table, below the root zones 20 and 22. Transpiration is the evaporation of moisture from a crop's leaves. The apple trees 12 and the broccoli 14 consume moisture from the soil of their respective root zones 20 and 22 by absorbing moisture through their respective roots. Some of the absorbed moisture is used by the apple tree to grow and produce fruit or by the broccoli to grow and flower, and some of the absorbed moisture is held in the leaves of the apple tree or broccoli for release into the atmosphere via transpiration. Desorption can occur when the amount of moisture held by the section of soil that includes the root zones 20 and 22 is greater than the available moisture holding capacity of soil below the respective root zones 20 and 22. When this occurs and there is nothing in the respective root zones 20 and 22 to prevent the movement of the moisture toward the soil below the respective root zones 20 and 22, some of the moisture will leave the respective root zones 20 and 22 for the soil below.

FIG. 2 is a schematic view of a process for monitoring moisture added to a section of soil during a period, according to an embodiment of the invention. The process may be used to determine the contribution of cultivator-supplied irrigation to the total amount of moisture that enters the section of soil during the period. The process includes: a) determining, at a step 40, an amount of moisture, Wᵢₙᵢₜᵢₐₗ, in a section of soil at the beginning of a period, t₁; b) determining, at a step 42, an amount of moisture, Wᵢₙ, entering the section of soil during the period, t₁₋ₘ, via natural precipitation; c) determining, at a step 44, an amount of moisture, Wₒᵤₜ, leaving the section of soil during the period t₁₋ₘ; d) determining, at a step 46, an amount of moisture, Wₜₒₜ, at the end of the period tₘ; e) determining, at a step 48, whether or not a cultivator-supplied irrigation event has occurred during the period t₁₋ₘ; and f) if yes, calculating, at step 50, the effect of the cultivator-supplied irrigation event on the section of soil.

By determining, in this manner, an amount of moisture that has entered a section of soil via cultivator-supplied irrigation, the person responsible for irrigating one's crops does not have to keep track and report the amount of moisture provided during irrigation and the duration of the irrigation. Thus, the person only needs to ensure that the irrigation is started and finished as desired. If something happens during the irrigation, such as the amount of moisture provided to the crops increases or decreases, the process can discover this and alert one to adjust the next irrigation's duration, amount of moisture provided, or both, to compensate for the previous irrigation event.

Determining Wᵢₙᵢₜᵢₐₗ may be performed in any desired manner that provides an accurate amount for Wᵢₙᵢₜᵢₐₗ. For example, in this and other embodiment, Wᵢₙᵢₜᵢₐₗ is determined by sensing the amount of moisture in a sub-section of the soil's section with a moisture probe 24 (FIG. 1). The probe 24 measures the amount of moisture in a section of soil by generating high energy neutrons, emitting these neutrons into the soil, and then sensing low energy neutrons in the soil. Because high energy neutrons lose energy when they collide with hydrogen, which moisture has, the concentration of low energy neutrons sensed by the probe correlates to the amount of moisture in the soil. After determining the amount of moisture in the sub-section, the cultivator can extrapolate this amount to the whole section of soil.

Determining Wᵢₙ entering the section of soil during the period t₁₋ₘ via natural precipitation may be performed in any desired manner that provides an accurate amount for Wᵢₙ. For example, in this and other embodiments Wᵢₙ via natural precipitation is determined by multiplying the amount of precipitation that falls during the period t₁₋ₘ by an efficiency factor, R. The amount of precipitation that falls is obtained from a local weather report, but may also be obtained by the cultivator by measuring the amount of precipitation that falls into a bucket located with the crops.

The efficiency factor R is a measure of the sprinkler design and to a lesser extent the respective root zones' 20 and 22 (FIG. 1) rate of absorbing the precipitation from the respective root zone's surface. Thus the efficiency factor R depends on the type of soil included in the respective root zones 20 and 22, the contour of the surface of the respective root zones 20 and 22, and the capacity of the respective root zones to hold additional moisture. Sand can absorb moisture quickly but can hold little of it, so a root zone that is predominantly sand will absorb much of the precipitation that falls onto it. Alternatively, clay absorbs moisture slowly but can hold much of it, so a root zone that is predominantly clay will lose much of the precipitation that falls onto it via evaporation and runoff, but will retain much of the precipitation that it does absorb for a long period. The efficiency factor R is obtained empirically and usually ranges between 0.1 and 0.7. In this and other embodiments of the process, the efficiency factor R is determined empirically from the plot of land 10 that the crops grow on. Thus, over time, the efficiency factor R can become very accurate for the respective root zones 20 and 22.

Determining Wₒᵤₜ leaving the section of soil during the period t₁₋ₘ may be performed in any desired manner that provides an accurate amount for Wₒᵤₜ. For example, in this and other embodiments Wₒᵤₜ is determined by multiplying a reference evaporation-transpiration number, Eₜₒ, by a crop coefficient factor, C. The Eₜₒ may be obtained from a local weather report and represents the amount of moisture that would have been transpired by cut grass, such as the grass found in many lawns, under the weather conditions during the previous period, usually 24 hours. Thus, the Eₜₒ provides an easy mechanism for accounting for the affects that the local weather conditions, such as air temperature, air humidity, solar radiation intensity and wind, have on the loss of moisture from the respective root zones 20 and 22 via transpiration. The crop coefficient factor C reflects a respective specific crop's transpiration relative to the transpiration of cut grass, and thus allows the cultivator/grower to determine the amount of moisture that a specific crop transpires from the Eₜₒ that is obtained from a local weather report.

The crop coefficient C typically ranges between 0.01 and 1.2 depending on the specific crop, and for each specific crop, C typically changes depending on the season. For example, C for Alfalfa is typically 0.6 during winter and 0.96 during summer or the peak growing season. C for a young apple tree is typically 0.10 during winter and 0.25 during summer. C for a mature apple tree is typically 0.10 during winter and 0.50 during summer. The crop coefficient C is obtained empirically and in this and other embodiments of the process, C is determined empirically from the plot of land 10 that the specific crops grow on. Thus, over time, the crop coefficient C can become very accurate for the specific crop grown from the respective root zones 20 and 22.

The period t₁₋ₘ may be any desired duration of time. For example in this and other embodiments, the period t₁₋ₘ is 24 hours because the Eₜₒ obtained from a local weather report is typically based on the 24 hours immediately preceding the report. If an Eₜₒ based on a different period can be obtained, then the period t₁₋ₘ may match the period that the Eₜₒ is based on. In other embodiments, the period t₁₋ₘ may be shorter in duration than the period that the Eₜ₀ is based on. For example, the cultivator may select a period that more closely corresponds with the period of a cultivator-supplied irrigation event to increase the accuracy of the calculation of the irrigation's affect on the respective root zones 20 and 22. In such embodiments, the cultivator may modify the Eₜₒ that is based on a 24 hour period to more accurately reflect the amount of moisture transpired during the period of the irrigation event.

Determining Wₜₒₜ may be performed in any desired manner that provides an accurate amount for Wₜₒₜ. For example, in this and other embodiment, Wₜₒₜ is determined by sensing the amount of moisture in a sub-section of the soil's section with a moisture probe 24 (FIG. 1). After determining the amount of moisture in the sub-section, the cultivator can extrapolate this amount to the whole section of soil.

Determining whether or not a cultivator-supplied irrigation event has occurred during the period t₁₋ₘ, may be performed in any desired manner. For example, in this and other embodiments, this determination is made by adding Wᵢₙ to Wₒᵤₜ and then subtracting this from Wᵢₙᵢₜᵢₐₗ. If this calculated amount of moisture is less than Wₜₒₜ, then an irrigation event has occurred during the period t₁₋ₘ. If, however, this calculated amount is more than or equal to Wₜₒₜ, then an irrigation event likely has not occurred during the period t₁₋ₘ.

If an irrigation event has occurred, then at step 50, the effect of the cultivator-supplied irrigation event on the section of soil may be analyzed. For example, in this and other embodiments an amount of moisture, Wᵢᵣᵣ, added to the respective root zones 20 and 22 may be determined, and then from this a future cultivator-supplied irrigation event may be accordingly modified. Wᵢᵣᵣ may be determined as previously discussed. Once this amount is determined, the cultivator can then determine the amount of moisture spent during the irrigation event by dividing Wᵢᵣᵣ by an irrigation efficiency factor, H. H ranges from 1.0, which represents a drip line buried in the respective root zones 20 and 22, to 0.15, which represents a Rain Bird® impact sprinkler mounted above the tree canopy. The irrigation efficiency factor H is obtained empirically, and in this and other embodiments of the process, H is determined empirically from the plot of land 10 that the specific crops grow on. Thus, over time, the irrigation efficiency factor H can become very accurate for the specific crop grown from the respective root zones 20 and 22 at a specific time of day during a specific season.

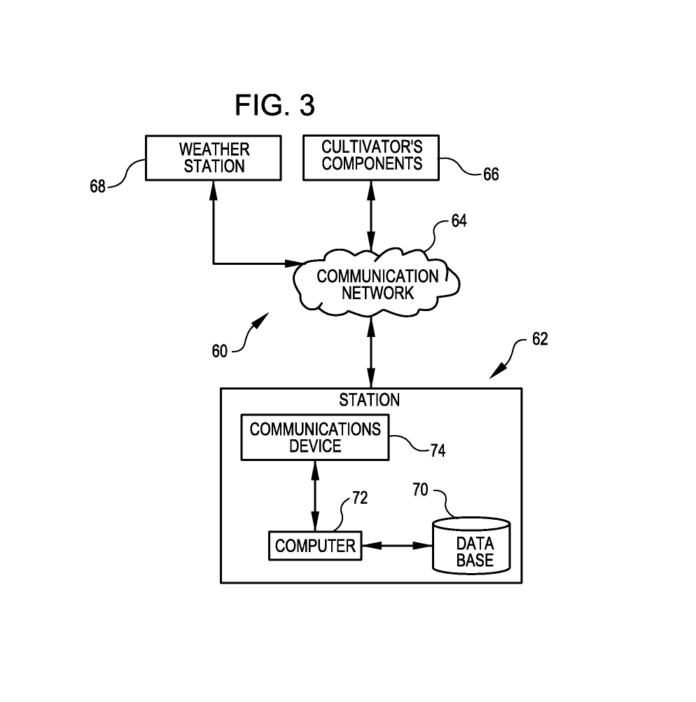

FIG. 3 is a schematic block diagram of a system 60 for monitoring moisture added to a section of soil during a period, according to an embodiment of the invention. The system 60 includes a station 62, not located with the cultivator, that communicates via a communication network 64 with the cultivator's components 66 located with the cultivator, such as the moisture probe 24 (FIG. 1), and a weather station 68 located near the plot of land 10 (FIG. 1) to obtain information for determining the various pieces of information needed to monitor moisture added to a section of the plot 10. In other embodiments of the system, the station 62 may be located with the cultivator. This can occur if the cultivator purchases the data files and application program disposed on storage media such as a floppy disc, compact disc, magnetic tape, or removable hard drive, that allow the cultivator's personal computer to monitor moisture added to a section of soil during a period.

The station 62 includes a database 70 of information that includes the three coefficients and historical data. The station 62 also includes electronic circuitry (not shown) having a processor (also not shown) that can execute instructions included in a software program, and a program (also not shown) that when executed by the processor causes the station 62 to monitor moisture added to a section of soil during a period.

The electronic circuitry, processor and software program may be any desired circuitry, processor and software program that allows the station 62 to monitor moisture added to a section of soil during a period. For example, in this and other embodiments, the station 62 includes a conventional personal computer 72 whose operating system software can be any desired system software such as Windows XP, Windows 7, OS X (Mac), or Linux, that can support the hardware and software used by the program to monitor moisture added to a section of soil during a period. In other embodiments, the station 62 may include a mobile device such as an iPhone, iPad, or Android. The electronic circuitry includes conventional circuitry and related hardware for receiving input from a user, executing instructions of the program, and conveying output to a technician and/or the cultivator. The station 62 also includes a communications device 74 that can be any desired modem that can support any desired networking protocol. For example, the modem and corresponding software can support TCP/IP networking protocol used to communicate via the Internet or the modem and corresponding software can support other networking protocols such as Ethernet local area network protocol or conventional wireless network protocols.

In other embodiments of the station 62, the station 62 includes a web server (not shown) to facilitate the transfer of information between the station 62 and the cultivator's components located with the cultivator and a weather station local to the plot of land 10 (FIG. 1). For example, the web server can include Windows NT as operating system software and an active server pages module (ASP.NET).

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A method for determining an amount of moisture that has entered a section of soil via irrigation, the method comprising:
sensing at a first moment in time a total amount of moisture in a sub-section of the section of soil;
in response to the amount sensed at the first moment in time, determining a total amount of moisture in the section of soil at the first moment in time;
sensing at a second, subsequent moment in time a total amount of moisture in a sub-section of the section of soil;
in response to the amount sensed at the second moment in time, determining a total amount of moisture in the section of soil at the second moment in time;
comparing the two, determined total amounts of moisture in the section of soil,
determining an amount of moisture that has entered the section of soil during a period between the first and second moments in time via natural precipitation;
determining an amount of moisture that has left the section of soil during the period between the first and second moments in time; and
adding to the comparison of the two, determined total amounts of moisture, the determined amount of moisture that has left the section of soil; and
subtracting the determined amount of moisture that has entered the section of soil from the comparison of the two, determined total amounts of moisture and the addition of the determined amount of moisture that has left the section of soil.

2. The method of claim 1 wherein the section of soil is a portion of land that is three feet by three feet.

3. The method of claim 1 wherein the section of soil is a portion of a land that is fifty miles by sixty miles.

4. The method of claim 1 wherein sensing a total amount of moisture at the first moment in time includes emitting into the soil neutrons having an amount of energy, and sensing neutrons having less energy than the emitted neutrons.

5. The method of claim 1 wherein sensing a total amount of moisture at the second moment in time includes emitting into the soil neutrons having an amount of energy, and sensing neutrons having less energy than the emitted neutrons.

6. The method of claim 1 wherein determining a total amount of moisture in the section of soil at the first moment in time includes extrapolating the total amount of moisture sensed in a sub-section of the section of soil to the section of soil.

7. The method of claim 1 wherein determining a total amount of moisture in the section of soil at the second moment in time includes extrapolating the total amount of moisture sensed in a sub-section of the section of soil to the section of soil.

8. The method of claim 1 wherein the sub-section in which the amount of moisture sensed at the second moment in time is the same sub-section in which the amount of moisture sensed in the first moment of time is sensed.

9. The method of claim 1 wherein comparing the two, determined total amounts of moisture in the section of soil includes subtracting the amount of moisture sensed at the first moment in time from the amount of moisture sensed at the second moment of time.

10. The method of claim 1 wherein determining an amount of moisture that has left the section of soil includes adding an amount that transpires from a plant rooted in the section of soil.

11. The method of claim 1 wherein determining an amount of moisture that has left the section of soil includes adding an amount that evaporates from the section of soil.

12. A storage medium storing a program that, when executed by a computer, causes the computer to determine an amount of moisture that has entered a section of soil via irrigation, the determination performed by the computer comprising:
determining a total amount of moisture in the section of soil at the first moment in time;
determining a total amount of moisture in the section of soil at a second moment in time;
comparing the two, determined total amounts of moisture in the section of soil;
determining an amount of moisture that has entered the section of soil during a period between the first and second moments in time via natural precipitation;
determining an amount of moisture that has left the section of soil during the period between the first and second moments in time;
adding to the comparison of the two, determined total amounts of moisture, the determined amount of moisture that has left the section of soil; and
subtracting the determined amount of moisture that has entered the section of soil from the comparison of the two, determined total amounts of moisture and the addition of the total amount of moisture that has left the section of soil.
